(19) United States
(12) Patent Application Publication
(10) Pub. No.: US 2009/0087667 A1
(43) Pub. Date: Apr. 2, 2009

(54) Multilayer coating film-forming method

(75) Inventors: Yasuhiro Tomizaki, Hiratsuka-shi (JP); Kojiro Kadowaki, Hiratsuka-shi (JP)

Correspondence Address: WENDEROTH, LIND & PONACK, L.L.P., 2033 K STREET N. W., SUITE 800, WASHINGTON, DC, 20006-1021, US

(73) Assignee: KANSAI PAINT CO., LTD.

(21) Appl. No.: 12/232,996

(22) Filed: Sep. 26, 2008

(30) Foreign Application Priority Data
Sep. 28, 2007 (JP) 2007-253086

(51) Int. Cl. B05D 1/36; B05D 3/02; B32B 27/38

(52) U.S. Cl. 428/413; 427/385.5

(57) ABSTRACT

The present invention offers a method for forming multilayer coating film excelling in coated appearance by coating water-based base coat paint and acid/epoxy curing type clear coat paint by 2-coat-1-bake system, wherein the water-based base coat paint contains specific water-soluble onium salt compound which is a curing catalyst of the clear coat paint.

### TECHNICAL FIELD

This invention relates to a method for forming base coat coating film and clear coat coating film on a coating object by 2-coat-1-bake coating.

### BACKGROUND ART

In top coat coating of automobiles, 2-coat-1-bake coating has been widely used. This coating method comprises first applying a base coat paint to form a base coat coating film, applying onto the uncured base coat coating film a clear coat paint to form a clear coat coating film, and thereafter simultaneously curing the base coat coating film and clear coat coating film by heating. The multilayer coating film so obtained excels in coated appearance such as luster and depth.

To meet the recent need for improving acid resistance of coating film, acid/epoxy curing type clear coat paint as that to be used in 2-coat-1-bake coating is in demand. For example, JP Hei 7 (1995)-133340A discloses curable resin compositions which contain polyepoxide, carboxyl group- and/or cyclic acid anhydride group-containing curing agent and specific latent curing catalyst as the essential constituents. Use of the same paint enables to form coating film of excellent acid resistance.

As the base coat paint in the occasion of using the above clear coat paint, normally an acid/epoxy curing type base coat paint is not used but a paint comprising a curable resin composition containing, for example, a hydroxyl-containing resin such as hydroxyl-containing acrylic resin or the like and a curing agent such as melamine resin is used in general. Also as the base coat paint, the main current nowadays is to use water-based base coat paint in place of those having generally lower solid concentration and higher solvent content compared to clear paint, for reducing volatile organic solvent (VOC) consumption as encouraged in recent years.

Where such water-based base coat paint and clear coat paint as above are applied by 2-coat-1-bake system, there is a problem that degradation in coated appearance frequently takes place, probably due to reduction in curability (non-uniform curing) at the interface of base coat coating film and clear coat coating film in the uncured multilayer coating film formed upon lamination of an acid/epoxy resin curing type clear coat coating film on the uncured water-based base coat coating film.

### DISCLOSURE OF THE INVENTION

The object of the present invention is to offer a method of forming multilayer coating film excelling in coated appearance, by applying water-based base coat paint and acid/epoxy curing type clear coat paint.

We have engaged in concentrative research work to now discover that the above object could be accomplished by a method of applying a water-based base coat paint and acid/epoxy curing type clear coat paint to form multilayer coating film, in which the water-based base coat paint contains specific water-soluble onium salt compound which is a curing catalyst of the clear coat paint, and completed the present invention.

Thus, the present invention provides a method of forming multilayer coating film, which comprises applying a water-based base coat paint onto a coating object to form a base coat coating film, applying onto the formed uncured base coat coating film a clear coat paint containing carboxyl- and/or cyclic acid anhydride group-containing compound and polyepoxide compound, to form a clear coat coating film, and then curing the base coat coating film and clear coat coating film simultaneously by heating, characterized in that

the water-based base coat paint comprises (A) a hydroxyl- and carboxyl group-containing resin, (B) a crosslinking agent and (C) a water-soluble onium salt compound having a molecular weight of 50-500, the content of the component (C) being 0.1-5 mass % based on the total amount of the components (A) and (B).

The water-based base coat paint used in the multilayer coating film-forming method of the present invention contains the low molecular weight water-soluble onium salt compound, and in the process of heat-curing after the application of a clear coat coating film, the onium salt compound migrates into the interface between the upper zone of the base coat coating film and the clear coat, concurrently with volatilization of water which is the chief component of the solvent in the water-based base coat paint.

At the interface of the clear coat layer with the base coat layer, curability decreases due to layer mixing with the base coat coating film, but when a water-based base coat paint according to the present invention is used, because of the above material migration the onium salt compound which is a curing catalyst for the clear coat paint is supplied from the base coat layer to the interfacial layer-mixing zone between the base coat layer and the clear coat layer, to suppress the decrease in curability at the interfacial layer-mixing zone.

Thus, according to the present invention it becomes possible to prevent the degradation in coated appearance attributable to non-uniform curing of the clear coat layer caused by the curability reduction at the interface of the base coat layer and clear coat layer.

In consequence, according to the multilayer coating film-forming method of the present invention, such conspicuous effect that multilayer coating film exhibiting very excellent coated appearance and acid resistance can be stably formed by 2-coat-1-bake coating of water-based base coat paint and acid/epoxy curing type clear coat paint.

Hereinafter the multilayer coating film-forming method of the present invention (which may be hereafter referred to as “the present method”) is explained in further details.

### Water-Based Base Coat Paint

In the present method, the water-based base coat paint to be applied onto a coating object first is a base coat paint containing (A) a hydroxyl- and carboxyl-containing resin, (B) a crosslinking agent and (C) a specific amount of a water-soluble onium salt compound having a molecular weight of 50-500.

### Hydroxyl- and Carboxyl-Containing Resin (A)

The hydroxyl- and carboxyl-containing resin (A) is subject to no particular limitation, so long as it contains at least one each of hydroxyl group and carboxyl group per molecule, and various resins known as being useful for paint can be used. As specific resin species, for example, acrylic resin, polyester resin, polyether resin, polycarbonate resin, polyurethane resin and the like can be named. As the hydroxyl- and carboxyl-containing resin (A), particularly acrylic resin, polyester resin and polyurethane resin which contain hydroxyl and carboxyl groups can be conveniently used.

The resin (A) preferably has a hydroxyl value within a range of generally 10-150 mgKOH/g, in particular, 20-125 mgKOH/g, inter alia, 30-100 mgKOH/g, from the viewpoint of curability. The resin (A) also preferably has an acid value within a range of generally 5-150 mgKOH/g, in particular, 20-120 mgKOH/g, inter alia, 30-100 mgKOH/g, from the viewpoint of water dispersibility.

### Hydroxyl- and Carboxyl-Containing Acrylic Resin

Hydroxyl- and carboxyl-containing acrylic resin can be synthesized, for example, by copolymerizing hydroxyl-containing unsaturated monomer (M-1), carboxyl-containing unsaturated monomer (M-2) and other copolymerizable unsaturated monomer (M-3), according to the accepted practice.

Hydroxyl-containing monomer (M-1) is a compound containing one each of hydroxyl group and unsaturated bond per molecule, and the hydroxyl group mainly acts as the functional group of the hydroxyl- and carboxyl-containing acrylic resin to react with the crosslinking agent. As the monomer (M-1), monoesterified products of (meth)acrylic acid with C₂₋₁₀ dihydric alcohols are preferred, examples of which include C₂₋₁₀ hydroxyalkyl esters of (meth)acrylic acid such as 2-hydroxyethyl (meth)acrylate, 2-hydroxypropyl (meth)acrylate, 4-hydroxybutyl (meth)acrylate and the like.

In the present specification, “(meth)acrylate” means acrylate or methacrylate, and “(meth)acrylic acid” means acrylic acid or methacrylic acid.

Also as the hydroxyl-containing unsaturated monomer (M-1), compounds obtained by ring-opening polymerization of above monoesterified products such as 2-hydroxyethyl (meth)acrylate further with ε-caprolactone or the like, for example, PLACCEL FA-1, PLACCEL FA-2, PLACCEL FA-3, PLACCEL FA-4, PLACCEL FA-5, PLACCEL FM-1, PLACCEL FM-2, PLACCEL FM-3, PLACCEL FM-4 and PLACCEL FM-5 (tradenames, Daicel Chemical Industries, Ltd.); polyethylene glycol mono(meth)acrylate, polypropylene glycol mono(meth)acrylate, 2-hydroxy-3-phenoxypropyl (meth)acrylate, 2-hydroxy-3-butoxypropyl (meth)acrylate, phthalic acid monohydroxyethyl (meth)acrylate and the like can be named, which can be used either alone or in combination of two or more.

Carboxyl-containing unsaturated monomer (M-2) is a compound having at least one each of carboxyl group and unsaturated bond per molecule, examples of which include acrylic acid, methacrylic acid, crotonic acid, itaconic acid, maleic acid, maleic acid anhydride and the like. These can be used either alone or in combination of two or more.

The carboxyl-containing unsaturated monomer can be used in such an amount as will render the acid value of the hydroxyl- and carboxyl-containing acrylic resin generally within a range of 5-150 mgKOH/g, in particular, 20-120 mgKOH/g, inter alia, 30-100 mgKOH/g.

The other copolymerizable unsaturated monomer (M-3) is a compound having one unsaturated bond per molecule, other than the monomers (M-1) and (M-2), specific examples of which include the following:

(1) monoesterified products of (meth)acrylic acid with C₁₋₂₀ monohydric alcohols: for example, C₁₋₂₀ alkyl esters of (meth)acrylic acid such as methyl (meth)acrylate, ethyl (meth)acrylate, propyl (meth)acrylate, n-butyl (meth)acrylate, iso-butyl (meth)acrylate, tert-butyl (meth)acrylate, 2-ethylhexyl (meth)acrylate, cyclohexyl (meth)acrylate, lauryl (meth)acrylate, isobornyl (meth)acrylate, tridecyl (meth)acrylate, and stearyl (meth)acrylate.

(2) aromatic unsaturated monomers: for example, styrene, α-methylstyrene and vinyltoluene;

(3) glycidyl-containing unsaturated monomers: compounds containing one each of glycidyl group and unsaturated bond per molecule, for example, glycidyl acrylate and glycidyl methacrylate;

(4) unsaturated bond-containing amide compounds: for example, acrylamide, methacrylamide, dimethylacrylamide, N,N-dimethylpropyl acrylamide, N-butoxymethyl acrylamide, N-methylol acrylamide, N-methylol methacrylamide and diacetonacrylamide;

(5) other unsaturated compounds: for example, vinyl acetate, vinyl propionate, vinyl chloride, versatic acid vinyl esters such as Veo Va 9 and Veo Va 10 (tradename, Japan Epoxy Resin Co.);

(6) unsaturated bond-containing nitrile compounds: for example, acrylonitrile and methacrylonitrile;

(7) acid group (excepting carboxyl group)-containing unsaturated monomers: compounds having at least one acid group other than carboxyl group and one unsaturated bond per molecule, for example, sulfonic acid group-containing unsaturated monomers such as vinylsulfonic acid and sulfoethyl (meth)acrylate; and acidic phosphoric acid ester type unsaturated monomers such as 2-(meth)acryloyloxyethyl acid phosphate, 2-(meth)acryloyloxypropyl acid phosphate, 2-(meth)acryloyloxy-3-chloropropyl acid phosphate and 2-methacryloyloxyethylphenylphosphoric acid.

These other unsaturated monomers (M-3) can be used each alone or in combination of two or more.

As the acrylic resin, also those prepared by emulsion polymerization in the presence of an aqueous dispersion stabilizer solution can be used.

As the dispersion stabilizer useful in the emulsion polymerization, besides anionic surfactant or nonionic surfactant, aqueous resins like acrylic resin having an acid value of around 5-150 mgKOH/g and a number-average molecular weight of around 5,000-30,000 can be conveniently used.

The emulsion polymerization can be carried out by any means known per se. In particular, acrylic emulsions prepared by multi-stage polymerization process are preferred because they give water-based base coat paint excelling in coating workability. For example, an acrylic emulsion prepared by the steps of first polymerizing a monomeric mixture containing no or little carboxyl-containing unsaturated monomer (usually containing no more than 3 mass % of the total monomers), and then carrying out the polymerization reaction using a monomeric mixture containing carboxyl-containing unsaturated monomer (of usually about 5-about 30 mass % of the total monomers) exhibits viscosity-expressing effect upon neutralization with a basic substance, and hence is preferred as it gives water-based base coat paint excelling in coating workability such an antisagging property.

Examples of the basic substance useful for the neutralization include hydroxides of alkali metals or alkaline earth metals such as sodium hydroxide, potassium hydroxide, lithium hydroxide, calcium hydroxide, barium hydroxide and the like; ammonia; primary monoamines such as ethylamine, propylamine, butylamine, benzylamine, monoethanolamine, neopentanolamine, 2-aminopropanol, 3-aminopropanol and the like; secondary monoamines such as diethylamine, diethanolamine, di-n- or diiso-propanolamine, N-methylethanolamine, N-ethylethanolamine and the like; tertiary monoamines such as dimethylethanolamine, trimethylamine, triethylamine, triisopropylamine, methyldiethanolamine, dimethylaminoethanol and the like; and polyamines such as diethylenetriamine, hydroxyethylaminoethylamine, ethylaminoethylamine, methylaminopropylamine and the like. These can be used either alone or in combination of two or more. Its use ratio can be normally within a range of 0.1-2.0 equivalent, in particular, 0.3-1.2 equivalent, to the carboxyl group in the acrylic emulsion prepared by the above multi-stage polymerization process.

The hydroxyl- and carboxyl-containing acrylic resin can have an acid value generally within a range of 5-150 mgKOH/g, preferably 20-120 mgKOH/g, inter alia, 30-100 mgKOH/g. When the acid value of the resin is less than 5 mgKOH/g, water-dispersibility may drop, and when it exceeds 150 mgKOH/g, the formed coating film may have reduced water resistance.

The hydroxyl- and carboxyl-containing acrylic resin can have a hydroxyl value generally within a range of 10-150 mgKOH/g, preferably 20-125 mgKOH/g, inter alia, 30-100 mgKOH/g. When the hydroxyl value of the resin is less than 10 mgKOH/g, curability may become insufficient, and when it exceeds 150 mgKOH/g, the formed coating film may have reduced water resistance.

From the viewpoint of the coated surface smoothness and weatherability of resulting coating film, the hydroxyl- and carboxyl-containing acrylic resin which is obtained by solution polymerization can have a number-average molecular weight generally within a range of 3,000-30,000, preferably 5,000-20,000, inter alia, 5,000-10,000. Where the resin has a number-average molecular weight less than 3,000, the formed coating film may show insufficient weatherability, and when it is more than 30,000, coated surface smoothness of the coating film may be impaired. Also the resin which is obtained by emulsion polymerization can have a number-average molecular weight generally no less than 100,000, preferably no less than 250,000, inter alia, no less than 500,000.

In the present specification, “number-average molecular weight” is a value calculated from the chromatogram measured with gel permeation chromatograph, based on the molecular weight of standard polystyrene.

### Hydroxyl- and Carboxyl-Containing Polyester Resin

Hydroxyl- and carboxyl-containing polyester resin can be synthesized by the means known per se, according to the accepted practice, for example, by esterification reaction of polybasic acid with polyhydric alcohol.

Polybasic acid is a compound having at least two carboxyl groups per molecule, examples of which include phthalic acid, isophthalic acid, terephthalic acid, succinic acid, adipic acid, azelaic acid, sebacic acid, tetrahydrophthalic acid, hexahydrophthalic acid, maleic acid, fumaric acid, itaconic acid, trimellitic acid, pyromellitic acid and anhydrides of these acids. Polyhydric alcohol is a compound having at least two hydroxyl groups per molecule, examples of which include diols such as ethylene glycol, propylene glycol, 1,3-propanediol, 1,4-butanediol, 1,5-pentanediol, 1,6-hexanediol, 2,2-diethyl-1,3-propanediol, neopentyl glycol, 1,9-nonanediol, 1,4-cyclohexanediol, hydroxypivalic acid neopentyl glycol ester, 2-butyl-3-ethyl-1,3-propanediol, 3-methyl-1,5-pentanediol, 2,2, 4-trimethylpentanediol, hydrogenated bisphenol A and the like; tri- or higher hydric polyol component such as trimethylolpropane, trimethylolethane, glycerin, pentaerythritol and the like; and hydroxycarboxylic acids such as 2,2-dimethylolpropionic acid, 2,2-dimethylolbutanoic acid, 2,2-dimethylolpentanoic acid, 2,2-dimethylolhexanoic acid, 2,2-dimethyloloctanoic acid and the like.

It is also permissible to have α-olefin epoxide such as propylene oxide, butylene oxide and the like or monoepoxy compound such as CARDURA E10 (tradename, HEXION Specialty Chemicals Co., a glycidyl ester of synthetic highly branched saturated fatty acid) and the like react with an acid, and to introduce the resulting compound into polyester resin.

Introduction of carboxyl groups into polyester resin can be effected by such method as, for example, after the esterification reaction of polybasic acid with polyhydric alcohol as above, further reacting the reaction product with polybasic acid or anhydride thereof, such as trimellitic acid or trimellitic anhydride; or adding acid anhydride to hydroxyl-containing polyester to half-esterify the same.

The hydroxyl- and carboxyl-containing polyester resin may be a fatty acid-modified polyester resin which is modified with (semi)drying oil fatty acid such as linseed oil fatty acid, coconut oil fatty acid, safflower oil fatty acid, soybean oil fatty acid, sesame oil fatty acid, perilla oil fatty acid, hempseed oil fatty acid, tall oil fatty acid, dehydrated castor oil fatty acid and the like. It is generally adequate that the modification amount with these fatty acid is not more than 30 mass % in terms of oil length. The hydroxyl- and carboxyl-containing polyester resin may also be one which is partially reacted with monobasic acid such as benzoic acid.

The hydroxyl- and carboxyl-containing polyester resin can have an acid value within a range of generally 5-150 mgKOH/g, preferably 20-120 mgKOH/g, inter alia, 30-100 mgKOH/g. Where acid value of the resin is less than 5 mgKOH/g, water dispersibility may be reduced. Whereas, when it exceeds 150 mgKOH/g, water resistance of the formed coating film may deteriorate.

The hydroxyl- and carboxyl-containing polyester resin can have a hydroxyl value within a range of generally 10-150 mgKOH/g, preferably 20-125 mgKOH/g, inter alia, 30-100 mgKOH/g. Where hydroxyl value of the resin is less than 10 mgKOH/g, curability may become insufficient, and when it exceeds 150 mgKOH/g, water resistance of the formed coating film may deteriorate.

The hydroxyl- and carboxyl-containing polyester resin can have a number-average molecular weight within a range of generally 500-50,000, in particular, 3,000-30,000, inter alia, 5,000-20,000. Where the number-average molecular weight of the resin is less than 500, the formed coating film may exhibit insufficient weatherability, while smoothness of the coated surface may be impaired when it exceeds 50,000.

It is preferable to neutralize the carboxyl groups in the hydroxyl- and carboxyl-containing polyester resin with a basic substance. As the basic substance to be used for the neutralization, basic substances similar to those exemplified as to the above hydroxyl- and carboxyl-containing acrylic resin can be used. The amount of the basic substance adequate for the neutralization is, based on the carboxyl groups in the resin, normally 0.1-2.0 equivalent, in particular, 0.3-1.2 equivalent.

### Hydroxyl- and Carboxyl-Containing Polyurethane Resin

Hydroxyl- and carboxyl-containing polyurethane resin can be obtained according to the accepted practice, for example, by reacting polyol with polyisocyanate.

Examples of low molecular weight polyols free of carboxyl group include dihydric alcohols such as ethylene glycol, diethylene glycol, propylene glycol, butylene glycol, hexamethylene glycol and the like; and trihydric alcohols such as trimethylolpropane, glycerin, pentaerythritol and the like. As those of high molecular weight, for example, polyetherpolyol, polyesterpolyol, acrylpolyol, epoxypolyol and the like can be named. As the polyetherpolyol, for example, polyethylene glycol, polypropylene glycol, polytetramethylene glycol and the like can be named. As the polyester polyol, for example, polycondensation products of alcohols such as aforesaid dihydric alcohol, dipropylene glycol, 1,4-butanediol, 1,6-hexanediol, neopentyl glycol and the like, with dibasic acid such as adipic acid, azelaic acid, sebacic acid and the like; lactone-derived ring-opening polymer polyol such as polycaprolactone; and polycarbonatediol and the like can be named.

As carboxyl group-containing polyols, for example, 2,2-dimethylolpropionic acid, 2,2-dimethylolbutanoic acid and the like can be named, 2,2-dimethylolpropionic acid being particularly preferred. When these polyols are used, a minor amount of a solvent such as N-methylpyrrolidone may be used for accelerating the reaction.

As the polyisocyanate to be reacted with above polyol, for example, aliphatic polyisocyanates such as hexamethylene diisocyanate, trimethylhexamethylene diisocyanate, dimeric acid diisocyanate, lysine diisocyanate and the like and biuret type adducts or isocyanurate ring adducts of these polyisocyanates; alicyclic diisocyanates such as isophorone diisocyanate, 4,4′-methylenebis(cyclohexylisocyanate), methylcyclohexane-2,4- (or 2,6-)diisocyanate, 1,3- (or 1,4-)di(isocyanatomethyl)cyclohexane, 1,4-cyclohexane diisocyanate, 1,3-cyclopentane diisocyanate, 1,2-cyclohexane diisocyanate and the like and biuret type adducts or isocyanurate ring adducts of these polyisocyanates; aromatic diisocyanate compounds such as xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4-toluidine diisocyanate, 4,4′-diphenylether diisocyanate, (m- or p-)phenylene diisocyanate, 4,4′-biphenylene diisocyanate, 3,3′-dimethyl-4,4′-biphenylene diisocyanate, bis(4-isocyanatophenyl)sulfone, isopropylidenebis-(4-phenylisocyanate) and the like and biuret type adducts or isocyanurate ring adducts of these polyisocyanantes; polyisocyanates having at least three isocyanate groups per molecule such as triphenylmethane-4,4′,4″-triisocyanate, 1,3,5-triisocyanatobenzene, 2,4,6-triisocyanatotoluene, 4,4′-dimethyldiphenylmethane-2,2′,5,5′-tetraisocyanate and the like and biuret type adducts or isocyanurate ring adducts of these polyisocyanates can be named.

The hydroxyl- and carboxyl-containing polyurethane resin can have an acid value within a range of generally 5-150 mgKOH/g, preferably 20-120 mgKOH/g, inter alia, 30-100 mgKOH/g. Where acid value of the resin is less than 5 mgKOH/g, there are occasions in which water dispersibility is reduced. Whereas, when it exceeds 150 mgKOH/g, water resistance of the coating film may deteriorate.

The hydroxyl- and carboxyl-containing polyurethane resin can have a hydroxyl value within a range of generally 10-150 mgKOH/g, in particular, 20-125 mgKOH/g, inter alia, 30-100 mgKOH/g. Where the hydroxyl value of the resin is less than 10 mgKOH/g, curability may become insufficient. When it exceeds 150 mgKOH/g, water resistance of the formed coating film may deteriorate.

The hydroxyl- and carboxyl-containing polyurethane resin can have a number-average molecular weight preferably within a range of 500-50,000, in particular, 3,000-30,000, inter alia, 5,000-20,000. Where number-average molecular weight of the resin is less than 500, the coating film may exhibit insufficient weatherability, while smoothness of the coated surface may be impaired when it exceeds 50,000.

It is desirable to neutralize carboxyl groups in the hydroxyl- and carboxyl-containing polyurethane resin with a basic substance. As the basic substance for the neutralization, basic substances similar to those exemplified as to the above hydroxyl- and carboxyl-containing acrylic resin can be used. The amount of the basic substance adequate for the neutralization is, based on the carboxyl groups in the resin, normally 0.1-2.0 equivalent, in particular, 0.3-1.2 equivalent.

### Crosslinking Agent (B)

As the crosslinking agent (B), those currently used in the field of paint can be used without particular limitation, so long as they are reactable with hydroxyl groups in the above-described resin (A) which is the base resin. Whereas, melamine resin and blocked polyisocyanate compound can be favorably used.

Specific examples of melamine resin include di-, tri-, tetra-, penta- or hexa-methylolmelamines and their alkyletherified products with alcohol (examples of the alkyl moiety including methyl, ethyl, propyl, isopropyl, butyl, isobutyl, 2-ethylhexyl and the like) and their condensates.

Commercial products of such melamine resins include, for example, Nihon Cytec Industries, Inc.'s Cymel 303, Cymel 323, Cymel 325, Cymel 327, Cymel 350, Cymel 370, Cymel 380, Cymel 385, Cymel 212, Cymel 251, Cymel 254 and Mycoat 776 (all tradenames); Monsanto Chemical Co's Regimin 735, Regimin 740, Regimin 741, Regimin 745, Regimin 746 and Regimin 747 (all tradenames); Sumitomo Chemicals Co.'s Sumimal M55, Sumimal M30W and Sumimal M50W (all tradenames); and Mitsui Chemicals, Inc.'s U-VAN series such as U-VAN20SB (tradename) and the like.

Particularly preferred melamine resins are those melamine resins whose mononuclear body content is at least 35 mass % and in which the methoxy group/butoxy group ratio lies within a range of 100/0-60/40 mol %, in particular, 100/0-70/30 mol %. Specific examples of such melamine resin include Nihon Cytec Industries, Inc.'s Cymel 325, Cymel 327, Cymel 350, Cymel 212, Mycoat 212, Mycoat 776 (all tradenames) and the like.

When the melamine resin is used as the crosslinking agent, sulfonic acid such as paratoluenesulfonic acid, dodecylbenzenesulfonic acid, dinonylnaphthalenesulfonic acid and the like, or salts of these acids with amine can be used as catalyst, where necessary.

Those melamine resins can be used either alone or in combination of two or more.

Blocked polyisocyanate compound is a polyisocyanate compound having at least two free isocyanate groups per molecule, whose free isocyanate groups are blocked with a blocking agent.

The reaction of the polyisocyanate compound with a blocking agent can be carried out under per se known conditions. The use ratio of the blocking agent to the polyisocyanate compound is preferably such that it is in slight excess to the total isocyanate groups in the polyisocyanate compound, so that no free isocyanate group should remain.

Examples of the polyisocyanate compound include aliphatic diisocyanate compounds such as hexamethylene diisocyanate, trimethylene diisocyanate, tetramethylene diisocyanate, pentamethylene diisocyanate, propylene diisocyanate, butylene diisocyanate, trimethylhexamethylene diisocyanate, dimeric acid diisocyanate, lysine diisocyanate and the like; alicyclic diisocyanate compounds such as isophorone diisocyanate, methylenebis(cyclohexyl isocyanate), methylcyclohexane diisocyanate, di(isocyanatomethyl)cyclohexane, cyclohexane diisocyanate, cyclopentane diisocyanate and the like; aromatic diisocyanate compounds such as xylylene diisocyanate, tolylene diisocyanate, diphenylmethane diisocyanate, naphthalene diisocyanate, toluidine diisocyanate, diphenylether diisocyanate, phenylene diisocyanate, biphenylene diisocyanate, dimethylbiphenylene diisocyanate, isopropylidenebis(4-phenyl isocyanate) and the like; polyisocyanate compounds having at least three isocyanate groups per molecule, such as triphenylmethane triisocyanate, triisocyanatobenzene, triisocyanatotoluene, dimethyldiphenylmethane tetraisocyanate and the like; urethane adducts formed by reacting hydroxyl groups of polyols such as ethylene glycol, propylene glycol, dimethylolpropionic acid, polyalkylene glycol, trimethylolpropane and the like, with polyisocyanate compounds at such a ratio that isocyanate groups are in excess; and biuret type adducts or isocyanurate ring type adducts of hexamethylene diisocyanate, isophorone diisocyanate, tolylene diisocyanate, xylylene diisocyanate, diphenylmethane diisocyanate, methylenebis(cyclohexyl isocyanate) and the like.

Of the above-named polyisocyanate compounds, aliphatic or alicyclic diisocyanate compounds and their biuret type adducts or isocyanurate ring type adducts can be favorably used from the viewpoint of weatherability.

Blocking agent is a compound for temporarily blocking free isocyanate groups, which normally dissociates when the blocked polyisocyanate compound is heated to curing temperature of coating film, for example, 100° C. or higher, preferably 130° C. or higher, to regenerate free isocyanate groups readily reactable with hydroxyl groups.

Examples of blocking agent include phenols such as phenol, cresol and the like; lactam compounds such as ε-caprolactam, δ-valerolactam and the like; aliphatic compounds such as methanol, ethanol, propyl alcohol, butyl alcohol, lauryl alcohol and the like; ether compounds such as ethylene glycol monomethyl ether, ethylene glycol monoethyl ether, ethylene glycol monobutyl ether, diethylene glycol monoethyl ether and the like; benzyl alcohol; glycolic acid; glycolic acid esters such as methyl glycolate, ethyl glycolate and the like; lactic acid; lactic acid esters such as methyl lactate, ethyl lactate, butyl lactate and the like; alcoholic compounds such as methylolurea, diacetone alcohol and the like; oxime compounds such as acetoxime, methyl ethyl ketoxime, diacetylmonooxime, benzophenone-oxime, cyclohexane-oxime and the like; active methylene compounds such as diethyl malonate, ethyl acetoacetate, methyl acetoacetate, acetylacetone and the like; mercaptans such as butyl mercaptan, t-butyl mercaptan, hexyl mercaptan, t-dodecyl mercaptan, thiophenol, methylthiophenol and the like; acid amide compounds such as acetanilide, acetanisidide, methacrylamide, acetic acid amide, benzamide and the like; imide compounds such as phathalimide, maleimide and the like; amine compounds such as diphenylamine, phenylnaphthylamine, carbazole, aniline, naphthylamine, butylamine and the like; imidazole compounds such as imidazole, 2-ethylimidazole and the like; urea compounds such as urea, thiourea, ethyleneurea, diphenylurea and the like; carbamic acid ester compounds such as phenyl N-phenylcarbamate; imine compounds such as ethyleneimine, propyleneimine and the like; sulfurous acid salt compounds such as sodium disulfite, potassium disulfite and the like; and pyrazole compounds such as 3,5-dimethylpyrazole, 3-methylpyrazole, 4-nitro-3,5-dimethylpyrazole, 4-bromo-3,5-dimethylpyrazole and the like.

Of the above blocking agents, oxime and pyrazole compounds are preferred from the viewpoints of curability and yellowing resistance of coating film.

Blocked polyisocyanate compounds can be used either alone or in combination of two or more.

As the aqueous blocked polyisocyanate compound, one whose isocyanate groups are blocked with a blocking agent such as hydroxycarboxylic acid or the like which has at least one hydroxyl group and at least one carboxyl group per molecule is preferred. Examples of the hydroxycarboxylic acid include hydroxypivalic acid, dimethylolpropionic acid and the like.

Such a blocked polyisocyanate compound blocked with hydroxycarboxylic acid exhibits good water dispersibility, as carboxyl groups which are hydrophilic are introduced into the blocked polyisocyanate compound by the carboxylic acid in the hydroxycarboxylic acid.

For improving coated appearance, blocked polyisocyanate compound preferably has a number-average molecular weight within a range of generally 250-4,000, in particular, 300-3,000, inter alia, 300-2,500.

Above-described crosslinking agents (B) can be used either alone or in combination of two or more.

Preferred blend ratios of the resin (A) and crosslinking agent. (B) in the water-based base coat paint based on the total amount of the components (A) and (B) are: the resin (A) is within a range of generally 50-90 mass %, in particular, 55-85 mass %, inter alia, 60-80 mass %; and the crosslinking agent (B), 10-50 mass %, in particular, 15-45 mass %, inter alia, 20-40 mass %.

### Onium Salt Compound (C)

The onium salt compound (C) to be contained in the water-based base coat paint according to the present method is a water-soluble onium salt compound having a molecular weight of 50-500. The term, “water-soluble”, as used in this specification signifies that the mass of the solute soluble in 100 g of 20° C. water, as expressed by the unit of gram, is at least 30, in particular, at least 50. The onium salt compound (C) is a compound not acting as a catalyst for curing the base coat paint, which however acts as a catalyst for acid/epoxy-curable type clear coat paint. The onium salt compound (C), which is contained in the water-based base coat paint according to the present method, migrates to the interfacial layer-mixing zone between the base coat layer and clear coat layer, the zone at which curing of the clear coat paint is retarded (becomes non-uniform), and promotes curing of the clear coat paint.

The onium salt compound (C) is a compound containing an element having a lone pair such as nitrogen, phosphorus, sulfur and the like, in which the lone pair is coordination bonded to proton or other cationic compound, specific examples including:

quaternary ammonium salt expressed by general formula (I): (R₁R₂R₃R₄N)X

quaternary phosphonium salt expressed by general formula (II): (R₁R₂R₃R₄P)X, and

tertiary sulfonium salt expressed by general formula (III): (R₁R₂R₃S)X.

In the above formulae (I)-(III), (R₁, R₂, R₃, and R₄ each independently stands for a hydrocarbon group, at least one hydrogen atom in the hydrocarbon group being optionally substituted with halogen atom or hydroxyl group. Examples of the hydrocarbon group include straight chain or branched alkyl or cycloalkyl (for example, methyl, ethyl, n- or iso-propyl, n-, iso-sec- or tert-butyl, cyclopentyl, cyclohexyl and the like), aryl (phenyl, tolyl and the like) and aralkyl (benzyl and the like). As examples of the X, acid and hydroxyl radicals of inorganic acids such as hydrochloric acid, sulfuric acid, phosphoric acid and the like, and those of organic acids such as citric acid, butyric acid, malonic acid, chlorinated acetic acid and the like can be named.

Specific examples of the onium salt compound (C) include tetraethylammonium chloride, tetraethylammonium bromide, tetrabutylammonium chloride, tetrabutylammonium bromide, diethyldibutylammonium bromide, laurylbenzyldimethylammonium chloride, tetraethylphosphonium chloride, tetraethylphosphonium bromide, tetrabutylphosphonium chloride, triethylsulphonium chloride and the like.

Of those, from the viewpoint of curability, quaternary ammonium salt, in particular, tetrabutylammonium chloride and tetrabutylammonium bromide, are preferred. Also from the viewpoints of coated surface smoothness and water resistance, the onium salt compound (C) preferably has a molecular weight within a range of 50-500, in particular, 100-450, inter alia, 200-400.

The onium salt (C) content in the water-based base coat paint is, based on the total amount of the resin (A) and crosslinking agent (B), preferably within a range of 0.1-5 mass %, in particular, 0.3-3 mass %, inter alia, 0.5-2 mass %. Where the onium salt compound (C) content is less than 0.1 mass % based on the total amount of the resin (A) and crosslinking agent (B), the curing-promoting effect at the interface becomes insufficient, leading to insufficient effect of improving coated appearance of the multilayer coating film. Where it exceeds 5 mass %, on the other hand, water resistance of formed coating film may decrease.

### Formulation of the Paint

The water-based base coat paint can be formulated by mixing and dispersing so far described-resin (A), crosslinking agent (B) and onium salt compound (C) in water, according to the conventional practice in the art of paint.

Pigment may also be blended in the water-based base coat paint.

Pigment which can be blended is not particularly limited and include coloring pigment, metallic pigment, iridescent pigment and extender pigment. Examples of coloring pigment include inorganic pigments such as titanium oxide, zinc flower, yellow iron oxide, red iron oxide, carbon black, Cadmium Red, Molybdate Red, chrom yellow, chrom oxide, Prussian Blue, Cobalt Blue and the like; and organic pigments such as azo pigment, diketopyrrolopyrrole pigment, benzimidazolone pigment, phthalocyanine pigment, quinacridone pigment, isoindoline pigment, isoindolinone pigment, vat pigment, perylene pigment, perinone pigment, indigo pigment, dioxane pigment and metal complex pigment. As metallic pigment, those typical are uncolored or colored metallic effect pigments of metals such as aluminum, copper, zinc, iron, nickel, tin and brass, their alloys or aluminum oxide, including unique vapor-deposited metallized film flakes. Examples of iridescent pigment include mica, mica with its surface coated with metal oxide, micaceous iron oxide, graphite pigment and hologram pigment. As extender pigment, for example, calcium carbonate, barium sulfate, clay, talc and the like can be named. These pigments can be used either alone or in combination of two or more.

Shapes of those metallic pigments and iridescent pigments are not particularly limited. They may also be further colored. For example, those having an average particle size (D50) of 2-50 μm and a thickness of 0.1-5 μm are preferred. Those having an average particle size within a range of 10-35 μm excel in brilliance and are particularly preferred.

Adequate blend amount of such pigment is, based on the total amount of the resin (A) and crosslinking agent (B), within a range of generally 0-250 mass %, in particular, 3-150 mass %.

A rheology controlling agent may also be added to the water-based base coat paint, from the viewpoint of coating workability. The rheology controlling agent is blended for the purpose of forming coating film free of unevenness and sagging. Generally those showing pseudo-plasticity can be used.

Besides the foregoing components, furthermore, additives customarily used with paint such as curing catalyst, dispersant, surface-regulating agent, thickener, antioxidant, ultraviolet ray absorber, light stabilizer, defoamer, antisettling agent and the like may be blended in the water-based base coat paint.

Concentration of non-volatile component in the water-based base coat paint at its application time is preferably within a range of normally 15-40 mass %, in particular, 20-35 mass %. Where the concentration of non-volatile component exceeds 40 mass %, viscosity of the paint rises and the coated surface smoothness may be impaired. Conversely, where it is less than 15 mass %, defective appearance such as unevenness may be invited due to the low viscosity.

### Coating Objects

The coating objects to which the method of the invention is applicable are not particularly limited, which may be, for example, metal substrates such as sheet steel, e.g., cold-rolled sheet steel, zinc-plated sheet steel, zinc alloy-plated sheet steel, stainless steel sheet and tin-plated sheet steel, aluminum plate and aluminum alloy plate; or various plastic materials. They may also be bodies of various vehicles such as automobiles, two-wheeled vehicles and container cars formed of these materials.

The coating objects may also be metallic surfaces of metal substrates or of car bodies, which have been given a surface treatment such as phosphate treatment, chromate treatment or complex oxide treatment.

Furthermore, the coating objects may be given an undercoating (e.g., cationic electrodeposition coating) and, depending on the occasion, further coating such as intermediate coating in advance.

### Application of the Water-Based Base Coat Paint

According to the present method, first the water-based base coat paint is applied onto such a coating object.

Application of the water-based base coat paint can be carried out after adjusting with a diluting solvent such as deionized water its coating viscosity to around 13-60 seconds, preferably around 15-40 seconds at 20° C. with, for example, Ford cup No. 4, by such means as air spray, airless spray, rotary atomizing coating or the like, under impression of static electricity where necessary, to a film thickness referring to cured coating film of generally about 5-about 45 μm, in particular, about 10-about 40 μm, inter alia, about 15-about 35 μm.

After application of the water-based base coat paint, the coated object is allowed to stand at ambient temperature for 1-20 minutes, where necessary, and further the base coat coating film is preheated. Thereafter onto the so formed uncured coated surface, a clear coat paint is applied. While most of the volatile components such as water and organic solvent in the base coat coating film volatilize off during the preheating, crosslinking reaction of the coating film scarcely progresses, and the percentage of gel in the base coat coating film after the preheating is normally around 0-5%. The preheating is preferably carried out at about 50-about 100° C., in particular, at about 60-about 80° C. The preheating time is preferably normally around 1-20 minutes, in particular, around 3-10 minutes. The preheating can be carried out by the means known Per se, for example, with a drying oven such as hot air oven, electric oven or infrared ray induction oven.

### Clear Coat Paint

As the clear coat paint to be used in the present method, paint referred to as acid/epoxy-curing type, i.e., clear coat paint comprising carboxyl- and/or cyclic acid anhydride group-containing compound and polyepoxide compound is suitable.

Carboxyl- and/or Cyclic Acid Anhydride Group-Containing Compound

Carboxyl- and/or cyclic acid anhydride group-containing compound to be used for the clear coat paint include polycarboxylic acid compound containing at least two carboxyl groups per molecule; cyclic acid anhydride compound containing at least one cyclic acid anhydride group per molecule; and carboxyl group-containing cyclic acid anhydride compound containing at least one each of carboxyl group and cyclic acid anhydride group per molecule.

The polycarboxylic acid compound includes, for example, low molecular weight compounds such as tetrahydrophthalic acid, hexahydrophthalic acid, trimellitic acid and the like; and vinyl type or polyester type polycarboxylic acid resins and the like. Here the vinyl type polycarboxylic acid resins include, for example, (co)polymers obtained through radical polymerization of carboxyl-containing vinyl monomer(s) (e.g., acrylic acid, methacrylic acid, adduct of hydroxyl-containing vinyl monomer with Himic anhydride and the like) and, where necessary, still other vinyl monomer(s); half-esterified (co)polymers obtained through radical polymerization of acid anhydride group-containing vinyl monomer(s) (e.g., itaconic anhydride, maleic anhydride and the like) and, where necessary, still other vinyl monomer(s) and subsequent half-esterification of the (co)polymers with alcohol (e.g., acetol, alkyl alchol, propargyl alcohol, methanol and the like (here “half-esterification” refers to the reaction to add monohydric alcohol to acid anhydride group to cause the latter's ring-opening. Upon the half-esterification, a group composed of a carboxyl group and carboxylic acid ester group is formed, which may be hereafter referred to simply as “half-ester group”); (co)polymers obtained through radical polymerization of half-ester group-containing vinyl monomer(s) and, where necessary, still other vinyl monomer(s); and half-esterified hydroxyl-containing (co)polymers obtained by radical (co)polymerizing hydroxyl-containing vinyl monomer(s) as the essential component and, where necessary, still other vinyl monomer(s) and subsequent half-esterification with acid anhydride compound (e.g., succinic anhydride and the like).

As the half-ester group-containing vinyl monomer, for example, compounds obtained by half-esterifying acid anhydride groups of acid anhydride group-containing vinyl monomers; and compounds obtained by adding acid anhydride to hydroxyl-containing vinyl monomers by half-esterification can be named.

Specific examples of the compounds obtained by half-esterifying acid anhydride groups of acid anhydride group-containing vinyl monomers include esters of vinyl monomers having acid anhydride groups such as maleic anhydride, itaconic anhydride and the like, with alcohol (e.g., acetol, allyl alcohol, propargyl alcohol, methanol and the like).

Specific examples of the compounds obtained by adding acid anhydride to hydroxyl-containing vinyl monomers by half-esterification include the compounds obtained by adding acid anhydride such as phthalic anhydride, hexahydrophthalic anhydride and the like to hydroxyl-containing vinyl monomers as exemplified in the following, by half-esterification.

The half-esterification can be carried out either before or after the (co)polymerization reaction. Examples of monohydric alcohols useful for the half-esterification include low molecular weight monoalcohols, e.g., methanol, ethanol, isopropanol, tert-butanol, isobutanol, ethylene glycol monomethyl ether, ethylene glycol monoethyl ether and the like. The half-esterification reaction can be carried out by ordinary method, at temperatures ranging from room temperature to about 80° C., where necessary, using tertiary amine as the catalyst.

Examples of other vinyl monomers include hydroxyl-containing vinyl monomers; (meth)acrylic acid esters; vinyl ethers and allyl ethers; olefinic compounds and diene compounds; hydrocarbon ring-containing vinyl monomers; and nitrogen-containing vinyl monomers.

Examples of the hydroxyl-containing vinyl monomer include C₂₋₈ hydroxyalkyl esters of acrylic acid or methacrylic acid such as 2-hydroxyethyl (meth)acrylate, 3-hydroxypropyl (meth)acrylate, 4-hydroxybutyl (meth)acrylate and the like; monoesters of polyether polyols such as polyethylene glycol, polypropylene glycol, polybutylene glycol and the like, with unsaturated carboxylic acid such as (meth)acrylic acid; monoethers of polyether polyols such as polyethylene glycol, polypropylene glycol, polybutylene glycol and the like with hydroxyl-containing unsaturated monomers such as 2-hydroxyethyl (meth)acrylate; diesters of acid anhydride group-containing unsaturated compound such as maleic anhydride or itaconic anhydride with glycols such as ethylene glycol, 1,6-hexanediol, neopentyl glycol and the like; hydroxyalkyl vinyl ethers such as hydroxyethyl vinyl ether; allyl alcohol; 2-hydroxypropyl (meth)acrylate; adducts of α, β-unsaturated carboxylic acid and monoepoxy compound such as CARDURA E10 (tradename, Showa Shell Sekiyu K.K.) or α-olefin epoxide; adducts of glycidyl (meth)acrylate and monobasic acids such as acetic acid, propionic acid, p-tert-butylbenzoic acid, fatty acids and the like; and adducts of aforesaid hydroxyl-containing monomers and lactones (e.g., //ε-caprolactone, γ-valerolactone and the like).

Examples of the (meth)acrylic acid esters include C₁₋₂₄ alkyl esters or cycloalkyl esters of (meth)acrylic acid such as methyl acrylate, ethyl acrylate, propyl acrylate, isopropyl acrylate, n-butyl acrylate, isobutyl acrylate, tert-butyl acrylate, hexyl acrylate, 2-ethylhexyl acrylate, n-octyl acrylate, decyl acrylate, stearyl acrylate, lauryl acrylate, cyclohexyl acrylate, methyl methacrylate, ethyl methacrylate, n-propyl methacrylate, isopropyl methacrylate, n-butyl methacrylate, isobutyl methacrylate, tert-butyl methacrylate, hexyl methacrylate, cyclohexyl methacrylate, 2-ethylhexylmethacrylate, octyl methacrylate, decyl methacrylate, lauryl methacrylate, stearyl methacrylate and the like; C₂₋₁₈ alkoxyalkyl esters of acrylic acid or methacrylic acid such as methoxybutyl acrylate, methoxybutyl methacrylate, methoxyethyl acrylate, methoxyethyl methacrylate, ethoxybutyl acrylate, ethoxybutyl methacrylate and the like; and aromatic ring-containing (meth)acrylates such as phenyl (meth)acrylate, phenylethyl (meth)acrylate, phenylpropyl (meth)acrylate, benzyl (meth)acrylate, phenoxyethyl (meth)acrylate and the like.

Examples of the vinyl ether and allyl ether include chain alkyl vinyl ethers such as ethyl vinyl ether, n-propyl vinyl ether, isopropyl vinyl ether, butyl vinyl ether, tert-butyl vinyl ether, pentyl vinyl ether, hexyl vinyl ether, octyl vinyl ether and the like; cycloalkyl vinyl ethers such as cyclopentyl vinyl ether, cyclohexyl vinyl ether and the like; allyl vinyl ethers such as phenyl vinyl ether, trivinyl ether and the like; aralkyl vinyl ethers such as benzyl vinyl ether, phenethyl vinyl ether and the like; and allyl ethers such as allyl glycidyl ether, allyl ethyl ether and the like.

Examples of the olefinic compound and diene compound include ethylene, propylene, butylene, vinyl chloride, butadiene, isoprene, chloroprene and the like.

Examples of the hydrocarbon ring-containing vinyl monomer include styrene, α-methylstyrene, vinyltoluene and the like.

Examples of the nitrogen-containing vinyl monomer include nitrogen-containing alkyl (meth)acrylates such as N,N-dimethylaminoethyl (meth)acrylate, N,N-diethylaminoethyl (meth)acrylate, N-tert-butylaminoethyl (meth)acrylate and the like; polymerizable amides such as acrylamide, methacrylamide, N-methyl (meth)acrylamide, N-ethyl (meth)acrylamide, N,N-dimethyl (meth)acrylamide, N,N-dimethylaminopropyl (meth)acrylamide, N,N-dimethylaminoethyl (meth)acrylamide and the like; aromatic nitrogen-containing monomers such as 2-vinylpyridine, 1-vinyl-2-pyrrolidone, 4-vinylpyridine and the like; polymerizable nitriles such as acrylonitrile, methacrylonitrile and the like; and allylamine and the like.

Copolymerization of above vinyl monomers can be carried out according to the accepted practice, while solution type radical polymerization method is the most suitable, in consideration of wide applicability and costs. That is, the object copolymer can be readily obtained by carrying out the copolymerization reaction in a solvent such as aromatic solvent, e.g., xylene or toluene; ketone solvent such as methyl ethyl ketone or methyl isobutyl ketone; ester solvent such as ethyl acetate, butyl acetate, isobutyl acetate or 3-methoxybutyl acetate; or alcohol solvent such as n-butanol or isopropyl alcohol; at temperatures within a range of about 60-about 150° C., in the presence of a polymerization initiator such as azobisisobutyronitrile, benzoyl peroxide or the like.

When a half-ester group-containing vinyl monomer or an acid anhydride group-containing vinyl monomer is used in the preparation of vinyl type polycarboxylic acid resin, suitable copolymerization ratio of the half-ester group-containing vinyl monomer or the acid anhydride group-containing vinyl monomer and still other vinyl monomer is as follows, based on the total amount of all the monomers: half-ester group-containing vinyl monomer or acid anhydride group-containing vinyl monomer, generally within a range of 5-40 mass %, in particular, 10-30 mass %; and the other vinyl monomer(s), generally within a range of 60-95 mass %, in particular, 70-90 mass %; from the viewpoint of curability and storage stability. Furthermore, when acid anhydride group-containing vinyl monomer is used, half-esterification reaction can be carried out after the copolymerization reaction, as aforesaid.

The vinyl type polycarboxylic acid resin preferably has a number-average molecular weight within a range of normally 1,000-10,000, in particular, 2,000-8,000. Where the number-average molecular weight of the resin is less than 1,000, acid resistance of the coating film may drop, and where it exceeds 10,000, its compatibility with polyepoxide compound drops, which may invite degradation in finished appearance of the coating film.

The vinyl type polycarboxylic acid resin preferably has an acid value within a range of generally 50-500 mgKOH/g, in particular, 80-300 mgKOH/g. Where the acid value of the vinyl type polycarboxylic acid resin is less than 50 mgKOH/g, the resulting clear coat paint shows reduced curability and its coating film occasionally shows less acid resistance. Whereas, when the acid value exceeds 500 mgKOH/g, compatibility of the resin with polyepoxide compound drops, which may impair the finished appearance of the coating film.

The polyester type polycarboxylic acid resin includes esters of polybasic acids with polyhydric alcohols, examples of the polybasic acid including at least divalent polybasic acids such as phthalic acid (anhydride), isophthalic acid, terephthalic acid, succinic acid (anhydride), adipic acid, fumaric acid, maleic acid (anhydride), tetrahydrophthalic acid (anhydride), hexahydrophthalic acid (anhydride), trimellitic acid (anhydride), methylcyclohexenetri- carboxylic acid, pyromellitic acid (anhydride) and the like. Examples of the polyhydric alcohol include ethylene glycol, propylene glycol, butylene glycol, diethylene glycol, butanediol, neopentyl glycol, cyclohexanedimethanol, 1,6-hexanediol, 2-butyl-2-ethyl-1,3-propanediol, 3-methyl-1,5-pentanediol, glycerin, trimethylolethane, trimethylolpropane, pentaerythritol, bis(hydroxyethyl)terephthalate, (hydrogenated)bisphenol, polyisocyanate polyol, diethanolamine, ethyldiethanolamine, triethanolamine and the like.

More specifically, those polyester type polycarboxylic acid resins can be obtained, for example, by single-stage reaction of such polybasic acid with polyhydric alcohol, under the blending condition in excess of carboxyl groups of the polybasic acid. Conversely, they can be also obtained by first synthesizing hydroxyl-terminated polyester type polymers through reaction of polybasic acid with polyhydric alcohol under the blending condition in excess of hydroxyl groups of the polyhydric alcohol, and post-adding thereto acid anhydride group-containing compound such as phthalic anhydride, hexahydrophthalic anhydride, succinic anhydride and the like.

From the viewpoint of finished appearance of the coating film, the polyester type polycarboxylic acid resin preferably has a number-average molecular weight within a range of generally 500-10,000, in particular, 800-5,000.

The polyester type polycarboxylic acid resin preferably has an acid value within a range of generally 50-500 mgKOH/g, in particular, 80-300 mgKOH/g. Where the acid value of the polyester type polycarboxylic acid resin is less than 50 mgKOH/g, the resulting clear coat paint shows reduced curability and its coating film occasionally shows less acid resistance. Whereas, when the acid value exceeds 500 mgKOH/g, compatibility of the resin with polyepoxide compound drops, which may impair the finished appearance of the coating film.

For improving compatibility with polyepoxide compound and improving adherability, hydroxyl groups may be introduced into the polyester type polycarboxylic acid resin. Introduction of hydroxyl groups can be effected, for example, by suspending the esterification reaction halfway in the reaction under the blending condition in excess of carboxyl groups. Conversely, under the blending condition in excess of hydroxyl groups, the introduction can be easily done by suspending the esterification reaction halfway or, after synthesizing a hydroxyl-terminated polyester polymer, and post-adding thereto an acid anhydride group-containing compound at such a ratio as will make the acid groups less than hydroxyl groups.

Of those polyester type polycarboxylic acid resins, carboxyl-containing high acid value polyester resins as described in the following are particularly preferred.

Carboxyl-containing high acid value polyester resins can be easily obtained, for example, by synthesizing polyester polyols by esterification reaction (which can be either of condensation reaction or ester-interchange reaction) of polyhydric alcohols such as ethylene glycol, butylene glycol, 1,6-hexanediol, trimethylolpropane, pentaerythritol and the like, with polyvalent carboxylic acids such as adipic acid, sebacic acid, terephthalic acid, isophthalic acid, phthalic anhydride, hexahydrophthalic anhydride, trimellitic anhydride and the like or lower alkylation products of these polyvalent carboxylic acids, under the condition in excess of hydroxyl groups to carboxyl groups (a mol of acid anhydride group is calculated as two mols of carboxyl group); and subjecting the resulting polyester polyols to half-esterification reaction with acid anhydride compounds such as phthalic anhydride, hexahydrophthalic anhydride, succinic anhydride, trimellitic anhydride and the like.

Above polyester polyols can be obtained under ordinary esterification reaction conditions. The polyester polyol preferably has a number-average molecular weight within a range of normally 350-4,700, in particular, 400-3,000, and a hydroxyl value within a range of normally 70-400 mgKOH/g, in particular, 150-350 mgKOH/g.

The half-esterification reaction of the polyester polyols for obtaining the carboxyl-containing high acid value polyester resins can be carried out at temperatures of from room temperature to about 80° C., following the accepted practice.

So obtained carboxyl-containing high acid value polyester resin preferably has a number-average molecular weight within a range of generally 800-5,000, in particular, 900-3,000, and an acid value within a range of generally 50-500 mgKOH/g, in particular, 100-400 mgKOH/g.

Examples of aforesaid cyclic acid anhydride compound include (co)polymers obtained by radical polymerization of 1,2-carboxylic anhydride such as maleic anhydride, succinic anhydride, dodecylsuccinic anhydride, tetrahydrophthalic anhydride, 3-methyltetrahydrophthalic anhydride, hexahydrophthalic anhydride, 3-methylhexahydrophthalic anhydride, Himic anhydride, Het anhydride, phthalic anhydride and the like; with above-described acid anhydride group-containing vinyl monomer and, where necessary, still other vinyl monomer as above-described.

Examples of the carboxyl-containing cyclic acid anhydride compound include copolymers obtained by radical polymerization of a compound like trimellitic anhydride, the carboxyl-containing vinyl monomer, acid anhydride group-containing vinyl monomer and, where necessary, still other vinyl monomer.

### Polyepoxide Compound

The polyepoxide compound used for the clear coat paint in the present method includes resins containing, on the average, at least about two epoxy groups per molecule. As the polyepoxide compound, those known per se can be used. Whereas, acrylic resins having on the average about 2-about 50 epoxy groups per molecule can be conveniently used, to provide cured coating film of favorable properties such as finished appearance, weatherability, acid resistance and the like.

Such acrylic resins can be synthesized by copolymerizing epoxy group-containing vinyl monomer and other vinyl monomer in the manner similar to that as described as to the foregoing carboxyl- and/or cyclic acid anhydride group-containing compound.

Examples of the epoxy group-containing vinyl monomer include glycidyl (meth)acrylate, allyl glycidyl ether, 3,4-epoxycyclohexylmethyl (meth)acrylate and the like. As the other vinyl monomer, those exemplified in relation to the carboxyl- and/or cyclic acid anhydride group-containing compound can be similarly used.

Hydroxyl groups can be introduced into the polyepoxide compound, in an amount as will give the compound a hydroxyl value not exceeding 100 mgKOH/g, to improve the compound's compatibility with the carboxyl- and/or cyclic acid anhydride group-containing compound and adherability of the coating film. The introduction of hydroxyl groups can be done by, for example, using, as a part of the other vinyl monomer to be copolymerized, a hydroxyl-containing vinyl monomer.

Those hydroxyl-containing vinyl monomers as exemplified in relation to the carboxyl- and/or cyclic acid anhydride group-containing compound can be used for this purpose.

Preferred amount of the epoxy group-containing vinyl monomer to be copolymerized is within a range of normally 5-60 mass %, in particular, 10-45 mass %, of the total amount of all the monomers, from the viewpoint of curability and storage stability of the clear coat paint. Also the amount of the other vinyl monomer to be copolymerized is preferably within a range of normally 40-95 mass %, in particular, 55-90 mass %, of the total amount of all the monomers.

The polyepoxide compound preferably has an epoxy group content within a range of normally 0.5-5.0 millimols/g, in particular, 0.65-4 millimols/g, inter alia, 0.8-3.5 millimols/g. Where the epoxy group content of the polyepoxide compound is less than 0.5 millimol/g, curability of the clear coat paint may decrease to degrade its coating film performance such as acid resistance. Whereas, when the epoxy group content exceeds 5.0 millimols/g, compatibility of the polyepoxide compound with the carboxyl- and/or cyclic acid anhydride group-containing compound may be impaired.

The polyepoxide compound also preferably has a number-average molecular weight within a range of generally 1,000-20,000, in particular, 1,100-15,000, inter alia, 1,200-10,000. Where the number-average molecular weight of the polyepoxide compound is less than 1,000, acid resistance of the cured coating film may drop, while when it exceeds 20,000, the resulting coating film may have reduced surface smoothness.

Preferred blend ratio of the carboxyl- and/or cyclic acid anhydride group-containing compound and polyepoxide compound in the clear coat paint used in the present method is, in terms of the equivalent ratio between carboxyl groups in the carboxyl- and/or cyclic acid anhydride group-containing compound to epoxy groups in the polyepoxide compound, within a range of generally 1:0.5-0.5:1, in particular, 1:0.7-0.7:1, inter alia, 1:0.8-0.8:1.

The clear coat paint is normally blended with a curing catalyst, for improved curability. As the curing catalyst, for example, onium salt compound, tertiary amine and later-described latent curing catalyst, which are customarily used in esterification reaction of acid with epoxy, can be used.

As the onium salt compound, those exemplified in respect of the water-based base coat paint can be similarly used, while those of molecular weight exceeding 500 and/or those which are water-insoluble can also be used as onium salt compound for clear coat paint.

Specific examples of onium salt useful for the clear coat paint include tetraethylammonium chloride, tetraethylammonium bromide, tetrabutylammonium chloride, tetrabutylammonium bromide, diethyldibutylammonium bromide, dimethyldioleylammonium chloride, dimethylbenzyllaurylammonium chloride, dimethyldicyclohexylammonium bromide, tetraethylphosphonium chloride, tetraethylphosphonium bromide, tetrabutylphosphonium chloride, dimethylbenzyllaurylphosphonium bromide, triethylsulfonium chloride and the like. Of these, tetraethylammonium chloride and tetraethylammonium bromide are preferred from the viewpoint of curability and storage stability.

As the tertiary amine compound, those compounds expressed by a general formula: (R₁R₂R₃N) can be named, in the formula R₁, R₂ and R₃ each independently standing for a hydrocarbon group, at least one hydrogen in the hydrocarbon group being optionally substituted with halogen atom or hydroxyl group. The hydrocarbon group includes straight chain or branched alkyl or cycloalkyl groups (e.g., methyl, ethyl, n- or iso-propyl, n-, iso-, sec-, or tert-butyl, cyclopentyl, cyclohexyl and the like); aryl (e.g., phenyl, tolyl and the like); and aralkyl (e.g., benzyl and the like).

Specific examples of tertiary amine compound include trialkylamines such as trimethylamine, triethylamine, triisopropylamine, tri-n-propylamine, tri-n-butylamine, N,N-dimethylhexylamine, N,N-dimethyloctylamine, N,N-dimethyldecylamine, N,N-dimethyllaurylamine, N,N-dimethylmyristylamine, N,N-dimethylpalmitylamine, N,N-dimethylstearylamine, N,N-dimethylbehenylamine, N,N-dimethylcocoalkylamine, N,N-dimethyloleylamine, N-methyldihexylamine, N-methyldioxtylamine, N-methyldidecylamine, N-methyldicocoalkylamine, N-methyldioleylamine and the like; trialkanolamines such as trimethanolamine, triethanolamine and the like; N,N-dialkylalkanolamines such as N,N-dimethylethanolamine, N,N-diethylethanolamine and the like; N-alkyldialkanolamines such as N-methyldiethanolamine, N-ethyldiethanolamine and the like; and N-alkylmorpholines such as N-methylmorpholine, N-ethylmorpholine and the like. These can be used either alone or in combination of two or more.

### Latent Curing Catalyst

For the clear coat paint used in the present method, a latent curing catalyst composed of (a) onium salt compound or tertiary amine and (b) acidic phosphoric acid ester is preferably used as the curing catalyst, for improving storage stability of the paint. In the latent curing catalyst, the components (a) and (b) can be in the form of either a mixture or reaction product.

As the onium salt compound or tertiary amine (a), those earlier named onium salt compounds or tertiary amines can be used. From the viewpoint to prevent degradation in electrostatic coatability caused by drop in electric resistance of clear coat paint, use of the tertiary amine as the component (a) is preferred.

Of those above-named, particularly such tertiary amine compounds expressed by the general formula: (R₁R₂R₃N), in which at least one of the R₁, R₂ and R₃ is a hydrocarbon group having at least 8 carbon atoms, in particular, at least 12, inter alia, at least 16, can be favorably used for preventing drop in electric resistance of the clear coat paint and improving storability while maintaining curability of the paint. In particular, methyldialkylamine and dimethylalkylamine whose alkyl moiety has 8 or more carbon atoms can be conveniently used, methyldialkylamine being the most preferred. Examples of the methyldialkylamine include N-methyldioctylamine, N-methyldidecylamine, N-methyldilaurylamine, N-methyldimyristylamine, N-methyldipalmitylamine, N-methyldistearylamine, N-methyldioleylamine, N-methyldibehenylamine, N-methyldicocoalkylamine, N-methyl-hardened beef tallow alkylamine and the like. Of these, N-methyldicocoalkylamine and N-methyl-hardened beef tallow alkylamine are particularly preferred. Examples of dimethylalkylamine include N,N-dimethyloctylamine, N,N-dimethyldecylamine, N,N-dimethyllaurylamine, N,N-dimethylmyristylamine, N,N-dimethylpalmitylamine, N,N-dimethylstearylamine, N,N-dimethyloleylamine, N,N-dimethylbehenylamine, N,N-dimethylcocoalkylamine, N,N-dimethyl-hardened beef tallow alkylamine and the like. Of these, N,N-dimethylcocoalkylamine and N,N-dimethyl-hardened beef tallow alkylamine are particularly preferred.

The acidic phosphoric acid ester (b) includes organic acidic phosphates or phosphites formed by substituting a part of hydrogen in phosphoric acid, phosphorous acid or condensates thereof with alkyl group or aryl group. The alkyl group may be either of straight chain alkyl or branched alkyl, examples of which include C₁₋₁₂ alkyl groups such as methyl, ethyl, n-propyl, iso-propyl, n-butyl, iso-butyl, sec-butyl, tert-butyl, n-pentyl, n-hexyl, n-heptyl, 2-ethylhexyl, n-decyl and the like.

Specific examples of the organic acidic phosphoric or phosphorous acid ester include dimetyl phosphate, diethyl phosphate, dipropyl phosphate, monobutyl phosphate, dibutyl phosphate, mono-2-ethylhexyl phosphate, bis(ethylhexyl) phosphate, monophenyl phosphate, diphenyl phosphate, mono-2-ethylhexyl phosphite and the like. Of these, diphenyl phosphate is particularly preferred.

The blend ratio of the component (a) and component (b) based on the total amount of the two components can be as follows: the component (a), generally within a range of 2-90 mass %, preferably 15-80 mass %, inter alia, 25-75 mass %; and the component (b), within a range of generally 10-98 mass %, preferably 20-80 mass %, inter alia, 25-75 mass %. Where the blend ratio of the component (a) is less than about 2 mass %, low temperature curability of the paint may be reduced. On the other hand, when it exceeds about 90 mass %, the paint may show reduced storage stability.

As the preferable combination of the component (a) and component (b) in the latent curing catalyst, combinations of methyldialkylamine or dimethylalkylamine whose alkyl moiety contains 8-24 carbon atoms, with diphenyl phosphate or bis(ethylhexyl) phosphate can be named.

The blend ratio of the curing catalyst in the clear coat paint is preferably within a range of generally 0.1-10 mass %, in particular, 0.1-5 mass %, based on the combined amount of the carboxyl- and/or cyclic acid anhydride group-containing compound and polyepoxide compound. Where the blend ratio of the curing catalyst is less than 0.1 mass %, sufficient curability of the coating film may not be obtained, and where it exceeds 10 mass %, storage stability may be impaired.

To the clear coat paint, such compounds as trimethyl ortho-acetate and the like which are generally referred to as desiccant may be added, to suppress deterioration of the paint by the moisture present in the paint or in the air, where necessary.

The clear coat paint may also be blended with pigment for paint, such as coloring pigment, extender, effect pigment or the like, of an amount as will not interfere with transparency of the paint, where necessary.

Specific examples of such pigments include coloring pigments such as titanium oxide, zinc flower, carbon black, Cadmium Red, Molybdate Red, chrom yellow, chromium oxide, Prussian Blue, Cobalt Blue, azo pigment, phthalocyanine pigment, quinacridone pigment, isoindoline pigment, vat pigment, perylene pigment and the like; extenders such as talc, clay, kaoline, baryta, barium sulfate, barium carbonate, calcium carbonate, silica, alumina white and the like; and effect pigments such as aluminum powder, mica powder, titanium oxide-coated mica powder and the like.

Furthermore, where necessary, various resins for paint such as acrylic resin, polyester resin, alkyd resin, silicone resin, fluorine-containing resin and the like, other than the carboxyl- and/or cyclic acid anhydride group-containing compound and polyepoxide compound, may be added to the clear coat paint. A minor amount of, for example, a crosslinking agent such as melamine resin, blocked polyisocyanate compound or the like may also be concurrently used. Still in addition, generally used paint additives such as UV absorber, light stabilizer, antioxidant, surface-regulating agent, defoamer and the like may also be blended, where necessary.

As the UV absorber, those known per se can be used, for example, benzotriazole-type absorbers, triazine type absorbers, salicylic acid-type absorbers, benzophenone-type absorbers and the like. The UV absorber content of the clear coat paint preferably is within a range of normally 0-10 mass %, in particular, 0.2-5 mass %, inter alia, 0.3-2 mass % of the total amount of solid resin, in respect of weatherability and yellowing resistance.

As the light stabilizer, those known per se can be used, for example, hindered amine light stabilizer. Content of such a light stabilizer in the clear coat paint preferably is within a range of normally 0-10 mass %, in particular, 0.2-5 mass %, inter alia, 0.3-2 mass % of the total amount of solid resin, in respect of weatherability and yellowing resistance.

The form of the clear coat paint is not particularly limited, while normally it is used as a solvent-based type paint composition. Organic solvent used in the clear coat paint can be, for example, aromatic or aliphatic hydrocarbon solvent; alcoholic solvent; ester solvent; ketone solvent; ether solvent or the like. More specifically, for example, toluene, xylene, SOLVESSO 150 (tradename, Exxon Mobil Corporation), SWAZOL 310, SWAZOL 1000 and SWAZOL 1500 (tradenames, Maruzen Petrochemical Co.) can be named. The same organic solvent as used in the synthesis of the carboxyl- and/or cyclic acid anhydride group-containing compound or the polyepoxide compound can be used in situ, or fresh solvent may be suitably added. The solid content of the clear coat paint can be within a range of normally 30-70 mass %, preferably 40-60 mass %.

### Coating of the Clear Coat Paint

After applying the water-based base coat paint and forming the base coat coating film, above-described clear coat paint is applied onto the uncured base coat coating film. Method of applying the clear coat paint is not particularly limited, but can be similar to any of those used for the water-based base coat paint, such as air spray, airless spray, rotary atomizing coating, curtain flow coating or the like. These coating methods may be carried out under impression of static electricity. Of these, electrostatic rotary atomizing coating is preferred. The amount of application of the clear coat paint in terms of cured coating film thickness is preferably within a range of normally about 10-about 50 μm, in particular, about 20-about 40 μm.

In the occasion of coating the clear coat paint, preferably the viscosity of the clear coat paint is suitably adjusted in advance with a solvent such as an organic solvent, to fall within a viscosity range suitable for the coating method used. For example, in case of electrostatic rotary atomizing coating, the viscosity is adjusted to about 15-about 60 seconds, in particular, about 20-about 40 seconds, as measured with Ford cup No. 4 viscosimeter at 20° C.

After applying the clear coat paint to form a clear coat coating film, the film may be further preheated for promoting volatilization of the volatile component where necessary, for example, at temperatures of about 50-about 80° C. for around 3-10 minutes.

### Heat-Curing of the Multilayer Coating Film

The base coat coating film and clear coat coating film formed as above are simultaneously cured by heating. The heating can be given by per se known heating means, for example, drying oven such as hot air oven, electric oven or infrared ray induction heating oven. Suitable heating temperature ranges about 80-about 180° C., preferably about 100-about 160° C. While the heating time is not critical, normally that of around 10-40 minutes is preferred.

### EXAMPLE

Hereinafter the invention is explained more specifically, referring to working Examples and Comparative Examples, it being understood that the invention is not limited to these Examples only. “Part” and “%” are invariably by mass, and coating film thickness is invariably that of cured coating film.

### Preparation of Hydroxyl- and Carboxyl-Containing Resin (A)

### Production Example 1

A reactor equipped with a thermometer, thermostat, stirrer, reflux condenser, nitrogen inlet pipe and dropping device was charged with 145 parts of deionized water and 1.2 parts of Newcol 562SF (note 1), which were stirred and mixed in gaseous nitrogen current. The temperature was raised to 80° C., and then 5% of the total amount of later specified monomeric emulsion (1) and 5.2 parts of 3% aqueous ammonium persulfate solution were introduced into the reactor and kept at 80° C. for 20 minutes.

Then the remainder of the monomeric emulsion (1) was dropped into the reactor over 3 hours, followed by 30 minutes' aging. Thereafter a monomeric emulsion (2) as specified later was added dropwise over an hour and a half, aged for two hours, and the reaction mixture was cooled to 30° C. under gradual addition of 89 parts of 1.5% aqueous dimethylethanolamine solution into the reactor. The content of the reactor was discharged while being filtered through 100-mesh Nylon cloth to provide a hydroxyl- and carboxyl-containing resin (A-1) having a solid content of 25%. Thus obtained resin (A-1) had a hydroxyl value of 22 mgKOH/g, an acid value of 30 mgKOH/g and an average particle size of 100 nm.

(note 1) Newcol 562SF: tradename, Nippon Nyukazai Co.,
Ltd., polyoxyethylene-ammonium alkylbenzene-sulfonate; active ingredient 60%.

Monomeric emulsion (1): Stirring and mixing 94.3 parts of deionized water, 17 parts of methyl methacrylate, 80 parts of n-butyl acrylate, 3 parts of allyl methacrylate and 1.2 parts of Newcol 562SF, the monomeric emulsion (1) was obtained.

Monomeric emulsion (2): Stirring and mixing 37.3 parts of deionized water, 15.4 parts of methyl methacrylate, 2.9 parts of n-butyl acrylate, 5.9 parts of hydroxyethyl acrylate, 5.1 parts of methacrylic acid, 0.5 part of Newcol 562SF and 1.7 parts of 3% aqueous ammonium persulfate solution, the monomeric emulsion (2) was obtained.

### Production Example 2

A reactor equipped with a thermometer, thermostat, stirrer, reflux condenser and dropping device was charged with 50 parts of butyl cellosolve, heated to 120° C. and further a mixture of 10 parts of styrene, 25 parts of methyl methacrylate, 20 parts of n-butyl methacrylate, 25 parts of n-butyl acrylate, 15 parts of hydroxyethyl methacrylate and 5 parts of acrylic acid as the monomers and 6 parts of 2,2-azobis(2-methylbutyronitrile) as the polymerization initiator was added thereto dropwise over 5 hours, followed by 2 hours' aging. Then N,N-dimethylethanolamine (of the amount to make the neutralization equivalent of the carboxyl group with amine 1.0) was added for neutralization. Diluting the reaction mixture with butyl cellosolve, a hydroxyl- and carboxyl-containing acrylic resin (A-2) having a solid content of 65% was obtained. Thus obtained resin (A-2) had a hydroxyl value of 72.5 mgKOH/g, an acid value of 39 mgKOH/g and a number-average molecular weight of 5,500.

### Production Example 3

A reactor equipped with a stirrer, reflux condenser, water-separator and thermometer was charged with 273 parts of trimethylolpropane, 200 parts of succinic anhydride and 490 parts of CARDURA ELOP (tradename, Japan Epoxy Resin Co., neodecanoic acid monoglycidyl ester), which were reacted at 100-230° C. for 3 hours. When sampling was conducted at this timepoint, the reaction mixture had a hydroxyl value of 350 mgKOH/g and a number-average molecular weight of 580. Further adding 192 parts of trimellitic anhydride and carrying out their condensation reaction at 180° C., a hydroxyl- and carboxyl-containing polyester resin (A-3) was obtained. Thus obtained resin (A-3) had an acid value of 49 mgKOH/g, hydroxyl value of 195 mgKOH/g and a number-average molecular weight of 1500.

### Preparation Examples of Water-Based Base Coat Paint

### Production Example 4

To 30.8 parts of the resin (A-2) as obtained in Production Example 2, 20 parts of the resin (A-3) as obtained in Production Example 3, 31.3 parts of Cymel 325 (tradename, Mitsui Cytec Industries Co., methoxyalkylated melamine resin), 140 parts of the resin (A-1) as obtained in Production Example 1 and TBAB (tetrabutylammonium bromide) were added under stirring, by the order stated, and mixed. Then Alumi Paste GX180A (tradename, Asahi Kasei Corporation, aluminum flake paste) of an amount corresponding to 20 parts of aluminum pigment was added under stirring, mixed and dispersed, followed by addition of dimethylethanolamine and deionized water to adjust the pH of the system to 8.0 and the viscosity, 30 seconds at 20° C., as measured with Ford cup No. 4. Thus water-based base coat paint 1 was obtained.

### Production Examples 5-16

Using compositions as shown in later-appearing Table 1, water-based base coat paints 2-13 were obtained in the manner similar to Production Example 4. The blend ratios forming each of the water-based base coat paint as shown in Table 1 are the solid mass ratios of individual components.

The particulars of (*1)-(*6) in the Table 1 are respectively as follows.

(*1) TBAB: tradename, Lion Akzo Co., tetrabutyl-ammonium bromide; water-soluble; molecular weight, 322

(*2) TBAC: tradename, Lion Akzo Co., tetrabutyl-ammoniuim chloride; water-soluble; molecular weight, 278

(*3) AQCB-50: tradename, Lion Akzo Co., alkylbenzyl-dimethylammonium chloride (the alkyl moiety is C₁₂₋₁₆ alkyl group); water-soluble; molecular weight, 355

(*4) TBPB: tradename, Lion Akzo Co., tetrabutyl-phosphonium bromide water-soluble; molecular weight, 339

(*5) LTMAB: tradename, Lion Akzo Co., lauryltrimethyl-ammonium bromide; difficultly water-soluble; molecular weight, 308

(*6) AQ2HT-75: tradename, Lion Akzo Co., dialkyl-dimethylammonium chloride (the alkyl moiety is C₁₄₋₁₈ alkyl group); difficultly water-soluble; molecular weight, 567.

Ammonium fluoride is water-soluble, and its molecular weight is 36.

TABLE 1

| | Production Example | | | | | | | | | | | | |
|---|---|---|---|---|---|---|---|---|---|---|---|---|---|
| | 4 | 5 | 6 | 7 | 8 | 9 | 10 | 11 | 12 | 13 | 14 | 15 | 16 |
| Water-based | 1 | 2 | 3 | 4 | 5 | 6 | 7 | 8 | 9 | 10 | 11 | 12 | 13 |
| base coat paint | | | | | | | | | | | | | |
| No. | | | | | | | | | | | | | |
| Resin (A-1) | 35 | 35 | 35 | 35 | 35 | 35 | 35 | 35 | 35 | 35 | 35 | 35 | 35 |
| Resin (A-2) | 20 | 20 | 20 | 20 | 20 | 20 | 20 | 20 | 20 | 20 | 20 | 20 | 20 |
| Resin (A-3) | 20 | 20 | 20 | 20 | 20 | 20 | 20 | 20 | 20 | 20 | 20 | 20 | 20 |
| Cymel 325 | 25 | 25 | 25 | 25 | 25 | 25 | 25 | 25 | 25 | 25 | 25 | 25 | 25 |
| GX180A | 20 | 20 | 20 | 20 | 20 | 20 | 20 | 20 | 20 | 20 | 20 | 20 | 20 |
| TBAB (*1) | 1.0 | 0.2 | 2.5 | 4.5 | | | | | 0.05 | 6.0 | | | |
| TBAC (*2) | | | | | 0.9 | | | | | | | | |
| AQCB-50 (*3) | | | | | | 1.1 | | | | | | | |
| TBPB (*4) | | | | | | | 1.1 | | | | | | |
| LTMAB (*5) | | | | | | | | | | | 1.0 | | |
| Ammonium fluoride | | | | | | | | | | | | 0.1 | |
| AQ2HT-75 (*6) | | | | | | | | | | | | | 1.8 |

### Production Examples of Resins for Clear Coat

Production Examples of Carboxyl- and/or Cyclic Acid Anhydride Group-Containing Compound

### Production Example 17

A 4-necked flask equipped with a stirrer, thermometer, condenser tube and nitrogen gas inlet was charged with 680 parts of SWAZOL 1000 (tradename, COSMO OIL Co., Ltd, a hydrocarbon type organic solvent) whose temperature was elevated to 125° C. under passing of nitrogen gas. After it reached 125° C., the nitrogen gas supply was stopped, and into the flask a monomeric mixture composed of the following monomers, solvent and polymerization initiator was dropped uniformly over 4 hours. In the following, p-tert-butylperoxy-2-ethyl hexanoate is a polymerization initiator.

| | parts |
|---|---|
| Styrene | 500 |
| Cyclohexyl methacrylate | 500 |
| Isobutyl methacrylate | 500 |
| Maleic anhydride | 500 |
| 2-Ethoxyethyl propionate | 1000 |
| p-tert-Butylperoxy-2-ethyl hexanoate | 100 |

While passing nitrogen gas therethrough at 125° C., the content of the flask was aged for 30 minutes, followed by further dropwise addition of a mixture of 10 parts of p-tert-butylperoxy-2-ethyl hexanoate and 80 parts of SWAZOL 1000 over an hour. Thereafter the reaction mixture was cooled to 60° C., and to which 490 parts of methanol and 4 parts of triethylamine were added, followed by 4 hours' half-esterification reaction under reflux. Thereafter 326 parts of superfluous methanol was removed under reduced pressure, to provide a solution of carboxyl-containing compound (X-1).

Thus obtained polymer solution had a solid content of 55 mass % and number-average molecular weight of about 3500. Also the half acid value of this polymer was 130 mgKOH/g.

### Production Example 18

A 4-necked flask equipped with a stirrer, thermometer, condenser tube and nitrogen gas inlet was charged with 650 parts of SWAZOL 1000 (tradename, COSMO OIL Co., Ltd, a hydrocarbon type organic solvent) whose temperature was elevated to 125° C. under passing of nitrogen gas. After it reached 125° C., the nitrogen gas supply was stopped, and into the flask a monomeric mixture composed of the following monomers, solvent and polymerization initiator was dropped uniformly over 4 hours.

| | parts |
|---|---|
| Methyl methacrylate | 40 |
| n-Butyl methacrylate | 1000 |
| n-Butyl acrylate | 600 |
| Styrene | 60 |
| Acrylic acid | 300 |
| 2-Ethoxyethyl propionate | 900 |
| p-tert-Butylperoxy-2-ethyl hexanoaote | 100 |

While passing nitrogen gas therethrough at 125° C., the content of the flask was aged for 30 minutes, followed by further dropwise addition of a mixture of 10 parts of p-tert-butylperoxy-2-ethyl hexanoate and 80 parts of SWAZOL 1000 over an hour. Aging the reaction mixture for additional 30 minutes, a solution of carboxyl-containing compound (X-2) was obtained.

Thus obtained polymer solution had a solid content of 55 mass % and number-average molecular weight of about 3400. Also the acid value of this polymer was 117 mgKOH/g.

### Production Example of Polyepoxide Compound

### Production Example 19

A 4-necked flask equipped with a stirrer, thermometer, condenser tube and nitrogen gas inlet was charged with 410 parts of xylene and 77 parts of n-butanol, whose temperature was raised to 125° C. under passing of nitrogen gas. After it reached 125° C., the nitrogen gas supply was stopped, and into which a monomeric mixture composed of the following monomers and a polymerization initiator was dropped uniformly over 4 hours. In the following, azobisisobutyronitrile is a polymerization initiator.

| | parts |
|---|---|
| Glycidyl methacrylate | 432 (30%) |
| n-Butyl acrylate | 720 (50%) |
| Styrene | 288 (20%) |
| Azobisisobutyronitrile | 72 |

While passing nitrogen gas therethrough at 125° C., the content of the flask was aged for 30 minutes, followed by further dropwise addition of a mixture of 90 parts of xylene, 40 parts of n-butanol and 14.4 parts of azobisisobutyronitrile over 2 hours. Further aging the reaction mixture for additional 2 hours, a solution of polyepoxide (Y-1) was obtained.

Thus obtained polymer solution had a solid content of 70 mass % and number-average molecular weight of 2000. The epoxy group content of the polymer was 2.12 millimols/g.

### Production Examples of Clear Coat Paint

### Production Examples 20-22

Using the polymers as obtained in above Production Examples 17-19 and those starting materials as given in later-appearing Table 2, the components at the blend ratios as given in the same Table 2 were mixed with a rotor blade stirrer to be formulated into paint, to provide clear coat paint No. 1-No. 3. The composition of each clear coat paint in Table 2 is indicated by solid mass ratio of each of the components.

In the Table 2, the particulars of (*7)-(*10) are respectively as follows.

(*7) TBAB: tradename. Lion Akzo Co., tertabutyl-ammonium bromide

(**) ARMIN M2C: tradename. Lion Akzo Co., N-methyldicocoalkylamine (tertiary amine, chief components; component having C₁₂ alkyl group 60%, one having C₁₄ alkyl group 22%, one having C₁₆ alkyl group 8%, and one having C₁₀ alkyl group 7%).

(*9) Phosphoric Acid ester: diphenyl phosphate

(*10) BYK-300: tradename, BYK-Chemie GmbH, surface regurating agent.

TABLE 2

| | Production Example | | |
|---|---|---|---|
| | 20 | 21 | 22 |
| Clear Coat Paint No. | 1 | 2 | 3 |
| Carboxyl-containing Compound (X-1) | 50 | | 50 |
| Carboxyl-containing Compound (X-2) | | 50 | |
| Polyepoxide Compound (Y-1) | 50 | 50 | 50 |
| TBAB (*7) | 1.0 | 1.0 | |
| ARMIN M2C (*8) | | | 1.0 |
| Phosphoric acid ester(*9) | 0.8 | 0.8 | 0.8 |
| BYK-300 (*10) | 0.1 | 0.1 | 0.1 |

### Multilayer Coating Film-Forming Method

### Coating Object

A zinc phosphated, 0.8 mm-thick dull steel plate was electrocoated with ELECRON 9600 (tradename, Kansai Paint Co., thermosetting epoxy resin type cationic electrodeposition paint) to a film thickness of 20 μm, which was then cured by heating at 170° C. for 30 minutes. Then AMILAC TP-65-2 (tradename, Kansai Paint Co., polyester resin/melamine resin type automobile intermediate paint) was air spray coated thereon to a film thickness of 35 μm and cured by heating at 140° C. for 30 minutes, to provide a coating object.

### Examples 1-9 and Comparative Examples 1-6

### Preparation of Test Panels

The intermediate paint-coated surface of each coating object was coated with each of the water-based base coat paints 1-13 as obtained in Production Examples 4-16 with their viscosity adjusted to 30 seconds at 20° C. as measured by Ford cup viscosimetry, using rotary atomizing electrostatic coater, under the conditions of: discharged amount, 300 cc; rotation speed, 25,000 rpm; shaping air pressure, 1.5 kg/cm²; gun distance, 30 cm and booth temperature/humidity, 15° C./75%, to a film thickness of 15 μm. The coated objects were allowed to stand for 2 minutes and preheated at 80° C. for 5 minutes. Then onto the uncured coated surfaces, the clear coat paints 1-3 as obtained in Production Examples 20-22 with their viscosity adjusted with SWAZOL 1000 (tradename, Cosmo Oil Co., Ltd., hydrocarbon solvent) to 25 seconds at 20° C. as measured with Ford cup No. 4 were coated with Minibell rotary atomizing electrostatic coater, under the conditions of discharged amount, 200 cc; rotation speed, 40,000 rpm; shaping air pressure, 1 kg/cm²; gun distance, 30 cm and booth temperature/humidity of 25° C./75° C., to a film thickness of 40 μm. After 10 minutes' standing, the coated objects were heated at 140° C. for 30 minutes, whereby the water-based base coat film and the clear coat film were simultaneously cured to provide the test panels.

Each of the test panels thus obtained were evaluated of the finished appearance in respect of the coated surface smoothness and water resistance by the following methods.

Coated surface smoothness: Smoothness of each coated surface was measured with Wave Scan (tradename, BYK Gardner Co.). With the Wave Scan, Long Wave value (LW) and Short Wave value (SW) were measured. Long Wave value is an index of the amplitude of surface roughness of the wavelength ranging 1.2-12 mm, which enables evaluation of large amplitude texture such as of orange peel coated surface. Short Wave value is an index of amplitude of surface roughness of the wavelength ranging 0.3-1.2 mm, which enables evaluation of small amplitude at fine texture of coated surface.

In each of Wave Scan values, less measured values indicate higher smoothness of the coated surface.

### Water Resistance:

Water resistance: The test panels were immersed in 40° C. warm water for 240 hours, withdrawn and dried at 20° C. for 12 hours. The multilayer coating film on each test panel was crosscut with a cutter to the depth reaching the substrate, to form one-hundred 2 mm×2 mm squares. Then an adhesive cellophane tape was stuck thereon, and rapidly peeled off at 20° C. The remaining number of the crosscut coating film was examined. Adherability was evaluated according to the following standard.

◯: One-hundred squares of the coating film remained.

Δ: Remaining number of the squares was 90-99.

×: Remaining number of the square was not more than 89.

Concurrently, appearance of the test panels after the water-resistant loading was visually evaluated according to the following standard.

◯: No occurrence of fog, whitening or blistering; favorable appearance.

Δ: More or less fog or whitening was observed.

×: Fog or whitening was observed and blistering also occurred.

TABLE 3

| | Example | | | | | | | | | Comparative Example | | | | | |
|---|---|---|---|---|---|---|---|---|---|---|---|---|---|---|---|
| | 1 | 2 | 3 | 4 | 5 | 6 | 7 | 8 | 9 | 1 | 2 | 3 | 4 | 5 | 6 |
| Water-based base coat paint No. | 1 | 1 | 1 | 2 | 3 | 4 | 5 | 6 | 7 | 8 | 9 | 10 | 11 | 12 | 13 |
| Clear coat paint No. | 1 | 2 | 3 | 1 | 1 | 1 | 1 | 1 | 1 | 1 | 1 | 1 | 1 | 1 | 1 |
| Coated surface smoothness (LW) | 10 | 10 | 10 | 12 | 10 | 12 | 10 | 11 | 11 | 17 | 16 | 15 | 16 | 17 | 17 |
| Coated surface smoothness (SW) | 5 | 6 | 5 | 8 | 6 | 8 | 5 | 7 | 7 | 12 | 11 | 12 | 11 | 12 | 14 |
| Water resistance (adherability) | ∘ | ∘ | ∘ | ∘ | ∘ | ∘ | ∘ | ∘ | ∘ | ∘ | ∘ | Δ | ∘ | ∘ | ∘ |
| Water resistance (appearance) | ∘ | ∘ | ∘ | ∘ | ∘ | ∘ | ∘ | ∘ | ∘ | ∘ | ∘ | Δ | ∘ | ∘ | ∘ |

1. A method of forming multilayer coating film, which comprises applying a water-based base coat paint onto a coating object to form a base coat coating film, applying onto the formed uncured base coat coating film a clear coat paint containing carboxyl- and/or cyclic acid anhydride group-containing compound and polyepoxide compound, to form a clear coat coating film, and then curing the base coat coating film and clear coat coating film simultaneously by heating, characterized in that
the water-based base coat paint comprises (A) a hydroxyl- and carboxyl group-containing resin, (B) a crosslinking agent and (C) a water-soluble onium salt compound having a molecular weight of 50-500, the content of the component (C) being 0.1-5 mass % based on the total amount of the components (A) and (B).

2. The method according to claim 1, in which the hydroxyl- and carboxyl-containing resin (A) is selected from hydroxyl- and carboxyl-containing acrylic resin, hydroxyl- and carboxyl-containing polyester resin and hydroxyl- and carboxyl-containing polyurethane resin, each having a hydroxyl value within a range of 10-150 mgKOH/g and an acid value within a range of 5-150 mgKOH/g.

3. The method according to claim 1, in which the crosslinking agent (B) is selected from melamine resin and blocked polyisocyanate compound.

4. The method according to claim 1, in which the water-based base coat paint contains 50-90 mass % of the hydroxyl- and carboxyl-containing resin (A) and 10-50 mass % of the crosslinking agent (B), based on the combined mass of the components (A) and (B).

5. The method according to claim 1, in which the onium salt compound (C) has a molecular weight of 200-400.

6. The method according to claim 1, in which the onium salt compound (C) is quaternary ammonium salt compound.

7. The method according to claim 1, in which the water-based base coat paint contains 0.3-3 mass % of the onium salt compound (C), based on the combined mass of the components (A) and (B).

8. The method according to claim 1, in which the water-based base coat paint further contains pigment.

9. The method according to claim 1, in which the carboxyl- and/or cyclic acid anhydride group-containing compound is selected from polycarboxylic acid compound containing at least two carboxyl groups per molecule; cyclic acid anhydride compound containing at least one cyclic acid anhydride group per molecule; and carboxyl group-containing cyclic acid anhydride compound containing at least one each of carboxyl group and cyclic acid anhydride group per molecule.

10. The method according to claim 1, in which the polyepoxide compound is an acrylic resin having, on the average, about 2-about 50 epoxy groups per molecule.

11. The method according to claim 1, in which the clear coat paint contains a latent curing catalyst composed of (a) onium salt compound or tertiary amine and (b) acidic phosphoric acid ester.

12. The method according to claim 11, in which the component (a) is a tertiary amine represented by a general formula: (R₁R₂R₃N) wherein R₁, R₂ and R₃ each independently stand for a hydrocarbon group, at least one hydrogen in the hydrocarbon group being optionally substituted with halogen atom or hydroxyl group, provided that at least one of R₁, R₂ and R₃ is a hydrocarbon group containing at least 8 carbon atoms.

13. The method according to claim 11, in which the component (a) is methyldialkylamine or dimethylalkylamine whose alkyl moiety has 8-24 carbon atoms and the component (b) is diphenyl phosphate or bis(ethylhexyl)phosphate.

14. The method according to claim 1, in which the clear coat paint contains the carboxyl- and/or cyclic acid anhydride group-containing compound and polyepoxide compound at such a ratio, in terms of the equivalent ratio between carboxyl groups in the carboxyl- and/or cyclic acid anhydride group-containing compound and epoxy groups in the polyepoxide compound, within a range of 1:0.5-0.5:1.

15. Articles coated by the method as described in claim 1.
